(19) United States
(12) Patent Application Publication
(10) Pub. No.: US 2005/0064376 A1
(43) Pub. Date: Mar. 24, 2005

(54) Colour coded system for writing

(76) Inventor: Sylvie Martin, St-Hubert (CA)

Correspondence Address: Eric Fincham, 316 Knowlton Road, Lac Brome, QC, J0E 1V0, CA

(21) Appl. No.: 10/942,595

(22) Filed: Sep. 16, 2004

(30) Foreign Application Priority Data
Sep. 24, 2003 (CA) 2,442,297

(51) Int. Cl. G09B 17/00

(52) U.S. Cl. 434/178

(57) ABSTRACT

In a publication having written text containing dialogue of at least two different characters, colours are used to identify the different characters.

### FIELD OF THE INVENTION

The present invention relates to written matter, and more particularly, relates to written matter containing dialogue with two or more characters and a method for writing dialogue.

### BACKGROUND OF THE INVENTION

In any publication wherein dialogue or speech from one or more people is utilised, it becomes necessary to clearly identify the speaker of the words which are written. This is usually accomplished by clearly identifying the speaker either immediately preceding or immediately after the words being attributed to the speaker. For example, in a newspaper article, the reporter will clearly identify who is being quoted using phraseology such as “John Smith said that he attended the meeting”.

While the attribution of quotations is relatively simple in a newspaper article, when there are a number of different people involved in a dialogue, such as when one is writing a book, it can sometimes become repetitious. In such instances, instead of using the name of the person, it is sometimes appropriate to use terms such as “he said” and/or “she stated.” In the case of books intended for a target audience of children, and because of the potential limited vocabulary, such a method naturally becomes very repetitious.

This approach can be compared to visual and/or oral presentations wherein the speech is much more natural. Thus, in live performances such as plays on the stage, it is not necessary to identify the speaker. Similarly, in movies or television, it is evident who is speaking and thus the dialogue is far less stilted than is the case with written dialogue.

The use of colour with the written word is known in the art. Thus, for example, in U.S. Pat. No. 3,715,812, the Patentee teaches the use of colours to put the accent on the means of pronouncing the word. A further approach is illustrated in U.S. Pat. No. 4,270,284 wherein there is taught a method of teaching a language using coloured text.

### SUMMARY OF THE INVENTION

It is an object of the present invention to provide printed matter which contains dialogue and wherein the use of repetitious words to indicate who is speaking is overcome.

It is a further object of the present invention to provide a method for writing dialogue wherein the dialogue from any one character is clearly identified without the use of repetitious phrases.

According to one aspect of the present invention, there is provided an improvement in a publication having a written text which contains dialogue of at least two different characters, the improvement wherein the dialogue of the first one of the characters is displayed in a first colour and the dialogue of a second one of the characters is displayed in a colour different from the colour used for the dialogue of the first character.

In a further aspect of the present invention, there is provided a method of writing a text containing dialogue for at least two characters, the method comprising the step of displaying the dialogue of each different character in a different colour.

As used herein, the term “publication” includes, without limitation, all types of publication, including books, magazines, newspapers, and the like and further including other medium such as a television screen, a computer screen, and electronic medium for storage such as the hard drive of a computer and/or portable storage devices.

The present invention is applicable to any written publication which contains dialogue, but is particularly suited to writing intended to be read by children. In this respect, the writing is very similar to what would be employed in a theatre or stage production in the sense that dialogue written for the theatre or stage does not require identification of the speaker since this is self-evident.

The use of the system of the present invention allows the writer to use more natural phraseology instead of a repetitive use of terms such as “he said” and “she said”. Rather, the written word can be the actual speech of the person and the reader will be clearly able to identify the speaker of the words.

### BRIEF DESCRIPTION OF THE DRAWINGS

Having thus generally described the invention, reference will be made to the accompanying drawings illustrating an embodiment thereof, in which:

FIG. 1 is a written text as presented in a normal manner when dialogue is spoken; and

FIG. 2 illustrates the text when written according to the present invention.

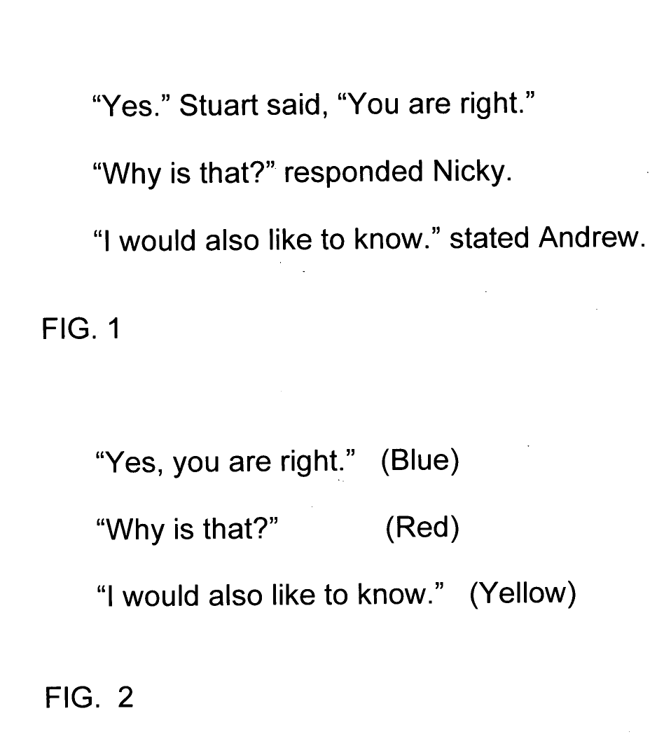

As may be seen in FIG. 1, each quotation must be identified as to who is the speaker. As previously stated, the proper choice of verbs makes the dialogue somewhat less repetitious. However, when writing for children, one must frequently utilize the same verb such as “he said”.

In the dialogue in FIG. 2, colour is used to identify the person to whom the words are being attributed.

The particular colours used may be any desired; it suffices to say that different colours are used for the different characters participating in the dialogue.

It will be understood that the above described embodiment is for purposes of illustration only and changes and modifications may be made thereto without departing from the spirit and scope of the invention.

1. In a publication having a written text containing dialogue of at least two different characters, the improvement wherein the dialogue of a first one of said characters is displayed in a first colour, and the dialogue of a second one of said characters is displayed in a colour different from the colour used for the dialogue of the first character.

2. The improvement of claim 1 wherein said publication is a book intended primarily for children.

3. The improvement of claim 1 wherein said publication is contained on an electronic storage medium.

4. The improvement of claim 1 wherein said publication is displayed on a computer screen.

5. The improvement of claim 1 wherein said publication is displayed on a television.

6. A method of writing a text containing dialogue for at least two characters comprising the step of displaying the dialogue of each different character in a different colour.

7. The method of claim 6 wherein said dialogue is displayed in a book.

8. The method of claim 6 wherein said dialogue is displayed on an electronic medium.
